(19) United States
(12) Patent Application Publication
(10) Pub. No.: US 2022/0222490 A1
(43) Pub. Date: Jul. 14, 2022

(54) INFORMATION PROCESSING DEVICE, METHOD AND PROGRAM

(71) Applicant: AISing LTD., Tokyo (JP)

(72) Inventors: Junichi IDESAWA, Tokyo (JP); Shimon SUGAWARA, Tokyo (JP)

(73) Assignee: AISing LTD., Tokyo (JP)

(21) Appl. No.: 17/610,184

(22) PCT Filed: Jul. 30, 2020
(86) PCT No.: PCT/JP2020/029357

§ 371 Date: Nov. 10, 2021

(30) Foreign Application Priority Data
Aug. 21, 2019 (JP) 2019-151518

(51) Int. Cl. G06K 9/62; G06N 20/00

(52) U.S. Cl. CPC G06K 9/6257; G06N 20/00; G06K 9/6261

(57) ABSTRACT

An information processing device performs machine learning utilizing a tree structure model configured by branching and hierarchically arranging a plurality of nodes respectively corresponding to hierarchically divided state spaces, the information processing device including: a learning object dataset reader configured to read a learning object dataset formed of a plurality of input columns and one or more output columns; an importance degree calculator configured to calculate importance degrees of the individual input columns based on the learning object dataset; an order generator configured to generate an order of the individual input columns to be a base of branch determination of the individual nodes, based on the individual importance degrees; and a machine learning circuitry configured to perform the machine learning based on the learning object dataset and the order.

### TECHNICAL FIELD

The present invention relates to a machine learning technology, and in particular, relates to a machine learning technology utilizing a tree structure.

### BACKGROUND ART

In recent years, the field of machine learning has become highly popular. In such a background, the inventors of the present application are proposing a new machine learning framework (learning tree) having a tree structure (Patent Literature 1).

FIG. 8 is an explanatory diagram illustrating the above-described new machine learning framework, that is, an explanatory diagram illustrating a structure of the learning tree. FIG. 8(a) illustrates the structure of the learning tree in the learning method, and FIG. 8(b) illustrates an image of a state space corresponding to the structure. It is clear from the figure that the learning tree structure is configured by branching and arranging individual nodes corresponding to individual hierarchically divided state spaces in a tree shape or a grid shape from a top node (a starting node or a root node) to a bottom node (a terminal node or a leaf node). Note that the figure illustrates an example of a case where d is 2 and n is 2 in the learning tree of N hierarchies, d dimensions and n divisions, and numbers 1-4 attached to four terminal nodes of the first hierarchy of the learning tree described in FIG. 8(a) correspond to four state spaces described in FIG. 8(b), respectively.

When performing learning processing using the learning tree, pieces of input data are successively made to correspond to the individual divided state spaces and they are stored in the individual state spaces. At the time, when data is newly inputted to the state space where the data has not been present until then, a new node is successively generated. Predicted output is calculated by taking an arithmetic mean of output values or output vectors corresponding to the individual pieces of data included in the individual state spaces after learning.

### CITATION LIST

### Patent Literature

Patent Literature 1: Japanese Patent Laid-Open No. 2016-173686

### SUMMARY OF INVENTION

### Technical Problem

In the conventional machine learning framework of this kind, when input is multi-dimensional, branch determination is performed from a high order of the tree structure in order of provided input columns.

FIG. 9 is an explanatory diagram for the conventional order of input columns used in the branch determination, that is, a branch column. In the case of the figure, the input is three-dimensional, and the order of the input columns is “input column 1”, “input column 2” and “input column 3” in order from left. Conventionally, the order of the input columns used in the branch determination is not taken into special consideration, and is determined simply from the high order along the order of the individual provided input columns. That is, in the example of the diagram, the branch determination is performed based on “input column 1” for the top node (root node), based on “input column 2” for the node of a stage one below, and based on “input column 3” for the node one further below.

However, such a configuration causes various inconveniences. For example, in the case of FIG. 9, if “input column 1” is the input column which hardly affects the output, when space division is performed in the top state space based on a value of the little significant “input column 1”, since a search thereafter is performed based on the divided spaces, there is a risk that a search space is inappropriately narrowed.

The present invention is implemented under the above-described technical background, and the object is to improve accuracy of machine learning by preventing a search space from being wrongfully limited depending on the order of the input columns to be a learning object.

The other objects and effects of the present invention will be easily understood by any person skilled in the art by referring to the following description.

### Solution to Problem

The above-described technical problem can be solved by a device, a method and a program or the like including a configuration below.

That is, in an information processing device which performs machine learning utilizing a tree structure model configured by branching and hierarchically arranging a plurality of nodes respectively corresponding to hierarchically divided state spaces, the information processing device relating to the present invention includes: a learning object dataset reading unit configured to read a learning object dataset formed of a plurality of input columns and one or more output columns; an importance degree calculation unit configured to calculate importance degrees of the individual input columns based on the learning object dataset; an order generation unit configured to generate an order of the individual input columns to be a base of branch determination of the individual nodes, based on the individual importance degrees; and a machine learning unit configured to perform the machine learning based on the learning object dataset and the order.

According to such a configuration, the state space is searched preferentially from the input column of a high importance degree so that the search space is not wrongfully limited. Therefore, since the state space to be originally searched can be fully searched, the accuracy of the machine learning can be improved. In addition, accompanying that, a learned model (prediction model) of excellent accuracy can be provided. Note that the word prediction means generating output data based on input data and the learned model.

The order generation unit may further include a detailed order generation unit configured to generate the order such that the input column of the high importance degree corresponds to an upper node in the tree structure model.

The individual importance degrees may be generated based on relevancy between the individual input columns and the individual corresponding output columns.

The relevancy may be an absolute value of a correlation coefficient between the individual input columns and the individual corresponding output columns.

The order generation unit may include: a maximum correlation coefficient input column specification unit configured to specify the input column for which the correlation coefficient is maximum among the individual input columns and perform incorporation into the order; a division unit configured to divide the correlation coefficient of the input column specified as having the maximum correlation coefficient by a predetermined numerical value; and a repetitive processing unit configured to repeatedly operate the maximum correlation coefficient input column specification unit and the division unit for a predetermined number of times and generate the order of the individual input columns.

The order generation unit may include an importance-degree-order order generation unit configured to generate the order of the individual input columns in order of the importance degrees of the individual input columns.

In addition, the present invention can be also conceived of as an information processing method. That is, in the information processing method which performs machine learning utilizing a tree structure model configured by branching and hierarchically arranging a plurality of nodes respectively corresponding to hierarchically divided state spaces, the information processing method relating to the present invention includes: a learning object dataset reading step of reading a learning object dataset formed of a plurality of input columns and one or more output columns; an importance degree calculation step of calculating importance degrees of the individual input columns based on the learning object dataset; an order generation step of generating an order of the individual input columns to be a base of branch determination of the individual nodes, based on the individual importance degrees; and a machine learning step of performing the machine learning based on the learning object dataset and the order.

Further, the present invention can be also conceived of as a computer program relating to the present invention. That is, in the computer program that makes a computer function as an information processing device which performs machine learning utilizing a tree structure model configured by branching and hierarchically arranging a plurality of nodes respectively corresponding to hierarchically divided state spaces, the computer program relating to the present invention includes: a learning object dataset reading step of reading a learning object dataset formed of a plurality of input columns and one or more output columns; an importance degree calculation step of calculating importance degrees of the individual input columns based on the learning object dataset; an order generation step of generating an order of the individual input columns to be a base of branch determination of the individual nodes, based on the individual importance degrees; and a machine learning step of performing the machine learning based on the learning object dataset and the order.

### Advantageous Effect of Invention

According to the present invention, the accuracy of machine learning can be improved by preventing a search space from being wrongfully limited.

### BRIEF DESCRIPTION OF DRAWINGS

FIG. 1 is a hardware configuration diagram of an information processing device.

FIG. 2 is a general flowchart relating to learning processing.

FIG. 3 is a general flowchart relating to branch column generation processing.

FIG. 4 is a detailed flowchart relating to importance degree analysis processing.

FIG. 5 is an explanatory diagram relating to a correlation coefficient.

FIG. 6 is a detailed flowchart relating to the branch column generation processing.

FIG. 7 is an explanatory diagram relating to branch column generation.

FIG. 8 is an explanatory diagram relating to a basic configuration of learning.

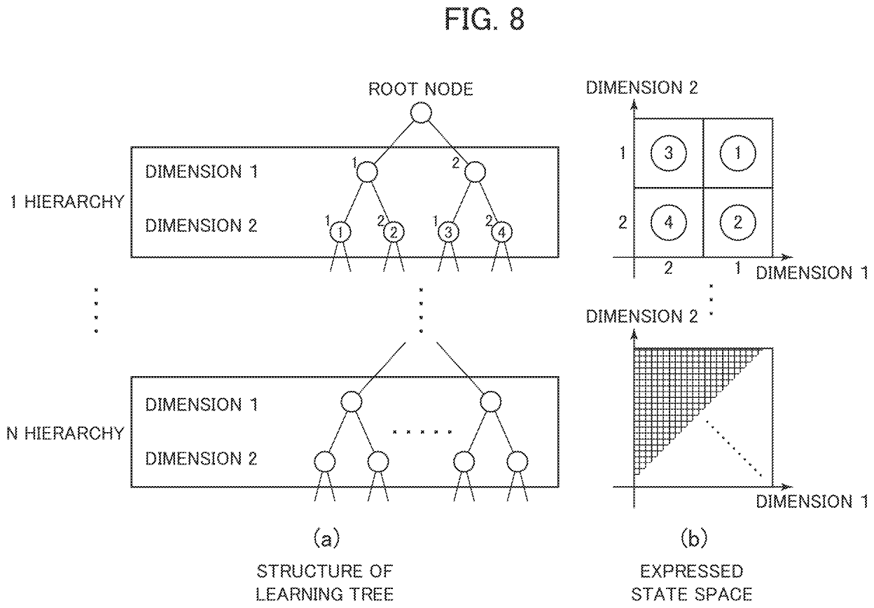

FIG. 9 is an explanatory diagram relating to a branch column.

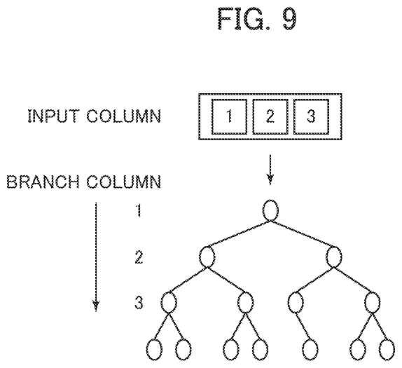

### DESCRIPTION OF EMBODIMENT

Hereinafter, one embodiment of the present invention will be described in details with reference to attached drawings.

### 1. First Embodiment

### 1.1 Configuration

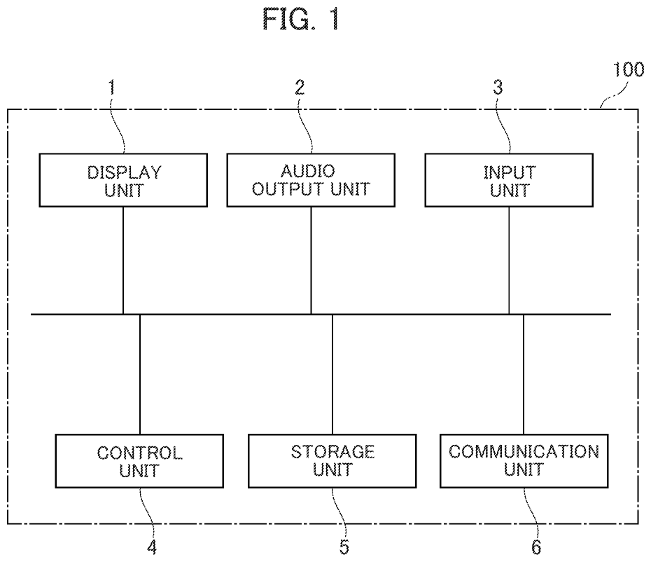

With reference to FIG. 1, the configuration of hardware of an information processing device 100 where machine learning processing and prediction processing or the like are executed relating to the present embodiment will be described. It is clear from the figure that the information processing device 100 relating to the present embodiment is configured by connecting a display unit 1, an audio output unit 2, an input unit 3, a control unit 4, a storage unit 5 and a communication unit 6 via a bus. The information processing device 100 is, for example, a personal computer (PC), a smartphone or a tablet terminal.

The display unit 1 is connected with a display or the like, controls display and provides a user with a GUI via the display or the like. The audio output unit 2 performs processing relating to audio information, and outputs audio through a speaker or the like. The input unit 3 processes signals inputted via a keyboard, a touch panel and a mouse or the like.

The control unit 4 is an information processing unit such as a CPU and a GPU, and performs overall control of the information processing device 100 and execution processing of a program of learning processing or prediction processing or the like. The storage unit 5 is a volatile or nonvolatile storage device such as a ROM, a RAM, a hard disk or a flash memory, and stores various kinds of data and programs such as learning object data, a machine learning program and a prediction processing program. The communication unit 6 is a communication unit which communicates with external equipment by cable or radio.

Note that the hardware configuration is not limited to the configuration relating to the present embodiment and the configuration and functions may be distributed or integrated. For example, it is needless to say that the processing may be distributively performed using the plurality of information processing devices or a mass storage may be further provided outside and connected with the information processing device 100 or the like. In addition, the processing may be performed by forming a computer network via the Internet or the like.

Further, the processing relating to the present embodiment may be implemented not only as software but also as a semiconductor circuit (IC or the like) such as an FPGA, that is, hardware.

### 1.2 Operation

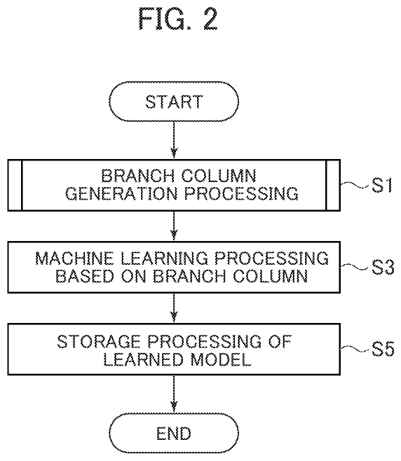

FIG. 2 is a general flowchart relating to the learning processing performed in the information processing device 100.

It is clear from the figure that, when the learning processing is started, generation processing of an order of input columns used in branch determination in nodes configuring a tree structure, that is, a branch column is performed (S1).

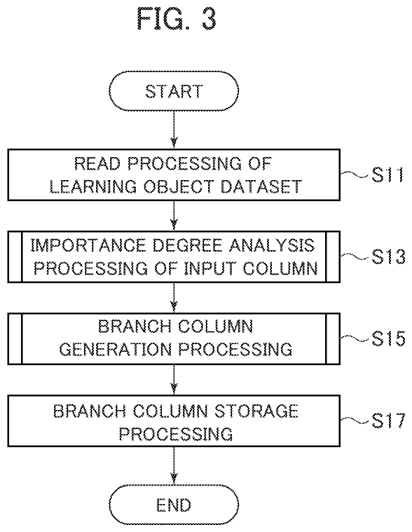

With reference to FIG. 3-FIG. 7, details of the branch column generation processing (S1) will be described.

FIG. 3 is a general flowchart relating to the branch column generation processing (S1). It is clear from the figure that the processing of reading a learning object dataset, that is, a set of the plurality of input columns and one or more output columns, from the storage unit 5 is performed (S11). Thereafter, based on the read learning object dataset, the processing of analyzing importance degrees of the individual input columns is performed (S13). Note that, in the present embodiment, as an example, the input columns are iₘₐₓ-dimensional, and the number of the output columns is one-dimensional.

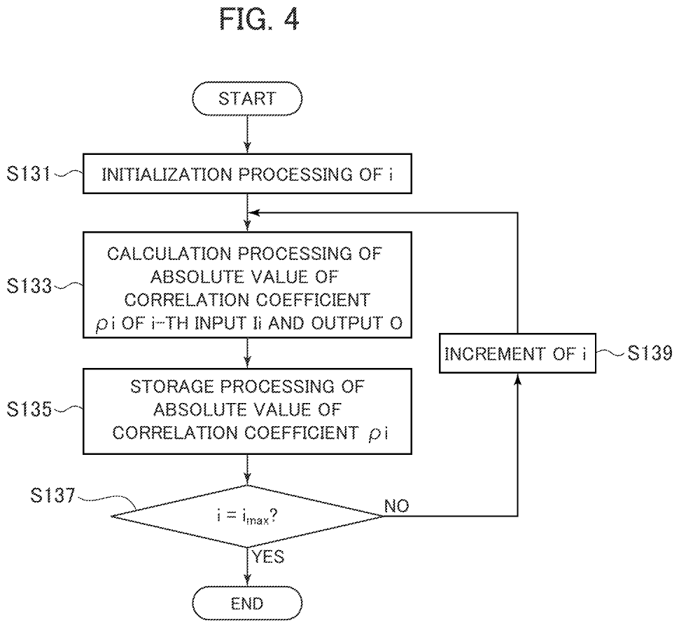

FIG. 4 is a detailed flowchart relating to the importance degree analysis processing. When the processing is started, the processing of initializing an eigenvalue i (integer) given for convenience to the individual input columns of the learning object dataset is performed (S131). When the initialization processing is completed, the processing of calculating a correlation coefficient ρᵢ between an i-th input column Ii and an output column O based on an expression below and calculating an absolute value of the ρᵢ is performed (S133). Note that σ_{X} indicates a standard deviation of the object input column, σ_{Y} indicates the standard deviation of the object output column and σ_{XY} indicates a covariance.

$$ρ = \frac{{σ}_{XY}}{{σ}_{X} {σ}_{Y}} \qquad [ Expression 1 ]$$

Thereafter, the processing of storing the absolute value of the correlation coefficient ρᵢ in the storage unit 5 is performed (S135). Note that, as to be described later, the absolute value of the correlation coefficient ρᵢ is a numerical value corresponding to the importance degree.

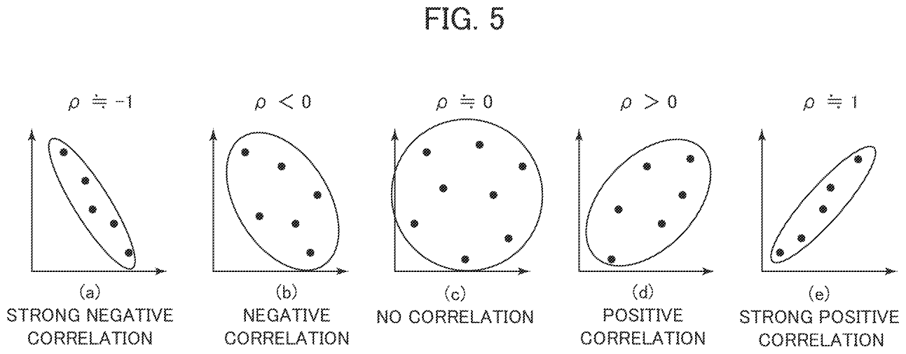

FIG. 5 is an explanatory diagram (a conceptual diagram) relating to the correlation coefficient. FIG. 5(a) indicates a case where there is a strong negative correlation between two random variables, FIG. 5(b) indicates the case where there is a weak negative correlation between the two random variables, FIG. 5(c) indicates the case where there is no correlation, FIG. 5(d) indicates the case where there is a weak positive correlation between the two random variables and FIG. 5(e) indicates the case where there is a strong positive correlation between the two random variables. By taking the absolute value of the correlation coefficient, for example, the case where there is some kind of correlation between the two random variables corresponding to FIG. 5(a), FIG. 5(b), FIG. 5(d) and FIG. 5(e) can be extracted.

Thereafter, the processing of comparing the value i with iₘₐₓ is performed, and when it is determined that the value i is still smaller than iₘₐₓ, the processing of incrementing i by 1 is performed (S139). Such processing (S133-S137NO, S139) is performed until the value i coincides with iₘₐₓ.

In the case where the value i coincides with iₘₐₓ (S137YES), the importance degree analysis processing (S13) is ended.

Returning to FIG. 3, when the importance degree analysis processing is ended, the branch column generation processing is performed (S15).

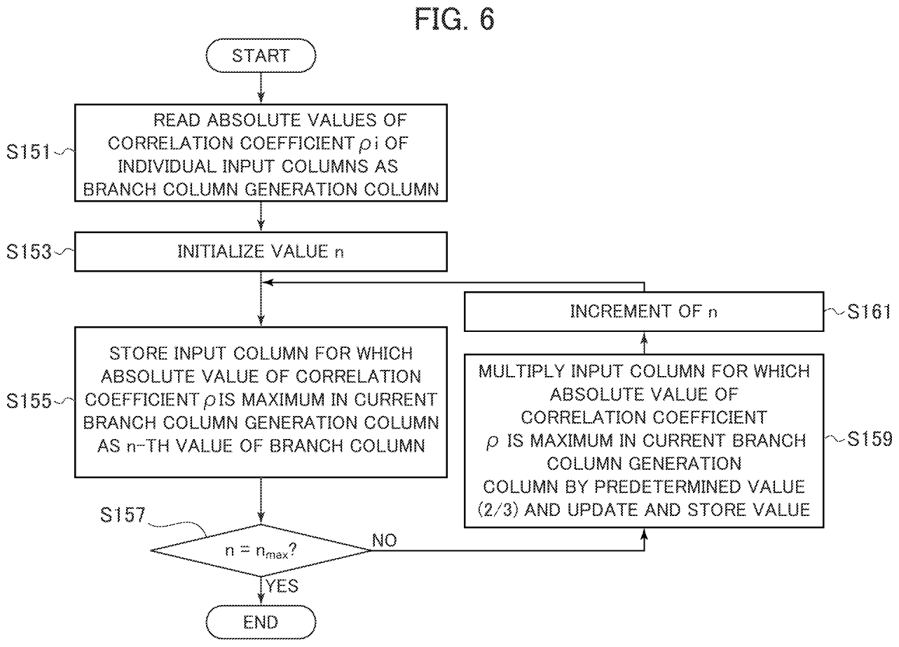

FIG. 6 is a detailed flowchart relating to the branch column generation processing. When the processing is started, the absolute value of the correlation coefficient ρᵢ relating to the individual input columns is read from the storage unit 5 as a branch column generation column (S151). Thereafter, the processing of initializing an integer value n indicating a length of a branch column for convenience is performed (S153).

After predetermined initialization processing, the input column for which the absolute value of the correlation coefficient ρ is maximum in the current branch column generation column is stored in the storage unit 5 as an n-th value of a branch column. Thereafter, whether or not n coincides with a predetermined maximum setting value nₘₐₓ is determined (S157). When it is determined that the value n does not coincide with nₘₐₓ (S157NO), the value is updated and stored by multiplying the absolute value of the correlation coefficient of the input column for which the absolute value of the correlation coefficient ρ is maximum in the current branch column generation column by a predetermined value, the value larger than 0 and smaller than 1 in particular, ⅔ for example in the present embodiment (S159). Then, n is incremented by 1, and the above-described processing (S155, S157NO, S159 and S161) is repeated again.

Thereafter, when it is determined that the value n coincides with nₘₐₓ (S157YES), the branch column generation processing is ended.

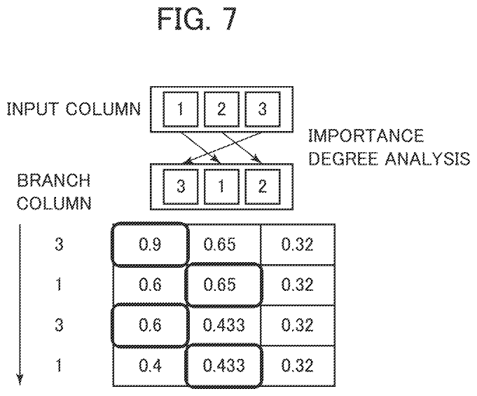

With reference to FIG. 7, the operation relating to the flowchart in FIG. 6 will be specifically described. FIG. 7 is an explanatory diagram relating to the branch column generation. In an example in the figure, an initial input column is three-dimensional, and numbers 1-3 are allocated to the individual input columns for convenience. In addition, it is assumed that the importance degree is calculated as 0.9 for the third input column, the importance degree is calculated as 0.65 for the input column 1 and the importance degree is calculated as 0.32 for the input column 2 by performing the importance degree analysis processing (S13) to the input columns. That is, the importance degrees are calculated as being big in order of “3-÷1-÷2” and the initial input columns are stored in the storage unit 5.

At the time, when the branch column generation processing (S15) is started, the processing of reading the absolute values of the correlation coefficient ρᵢ of the individual input columns is performed (S151), and n is initialized as 1 (S153). Thereafter, the third input column for which the absolute value of the correlation coefficient is 0.9 and is maximum is stored as the first branch column. Then, whether or not the value n is a maximum value nₘₐₓ (4 in the example in the figure) of n is determined (S157).

Here, since the value n does not coincide with the maximum value 4 (S157NO), the processing of multiplying the third input column for which the absolute value of the correlation coefficient ρ is maximum in the current branch generation column by ⅔ and updating and storing the branch column generation column is performed (S159). That is, the processing of multiplying the value 0.9 of the third input column by ⅔ and Attaining 0.6 is performed, and the importance degrees of the individual input columns “3, 1, 2” are updated to “0.6, 0.65, 0.32” respectively.

Thereafter, the value n is incremented by 1 and turned to 2, and the similar processing is repeated again. That is, the processing of storing the first input column that is the input column for which the absolute value of the correlation coefficient ρ becomes maximum (0.65) next as the branch column and then multiplying the numerical value by ⅔ is performed. The above-described processing is repeated until the value n coincides with 4. As a result, in the example in the figure, the branch column finally becomes “3→1→3→1”.

Returning to FIG. 3, when the branch column generation processing (S15) is ended, the processing of storing the generated branch column in the storage unit 5 is performed (S17), and the branch column generation processing (S1) is ended.

Returning to FIG. 2, when the branch column generation processing (S1) is ended, the machine learning processing based on the branch column is performed (S3). That is, the processing of performing the branch determination of the individual nodes from the high order of the tree structure based on the generated branch column and storing the individual data in the individual nodes is performed.

For example, in the case of using the branch column in FIG. 7, conditional determination is performed in order of the input columns “3→1→3→1” from a root node to a terminal node, and the individual input data is stored in the nodes. Note that, for examples of the machine learning processing, various kinds of known literature such as Japanese Patent Laid-Open No. 2016-173686 may be referred to.

When the machine learning processing based on the branch column is ended, the processing of storing a generated learned model in the storage unit 5 is performed (S5).

According to such a configuration, since a state space is preferentially searched from the input column of the high importance degree, a search space is not wrongfully limited. Therefore, the state space to be originally searched can be fully searched so that accuracy of machine learning can be improved.

Note that, by performing appropriate learning processing, the accuracy of the prediction processing utilizing the learned model is also improved.

### 2. Modification

The absolute value of the correlation coefficient is utilized as the importance degree in the importance degree analysis processing (S13) in the above-described embodiment, however, the present invention is not limited to such a configuration. Therefore, for example, various indexes other than the correlation coefficient can be utilized.

The processing of dynamically generating the branch column (S15) is performed after performing the importance degree analysis processing (S13) in the above-described embodiment, however, the present invention is not limited to such a configuration. Therefore, for example, the branch column may be generated simply in order of the importance degrees.

### INDUSTRIAL APPLICABILITY

The present invention is applicable in various industries or the like utilizing a machine learning technology.

### REFERENCE SIGNS LIST

1 Display unit
2 Audio output unit
3 Input unit
4 Control unit
5 Storage unit
6 Communication unit
100 Information processing device

1. An information processing device which performs machine learning utilizing a tree structure model configured by branching and hierarchically arranging a plurality of nodes respectively corresponding to hierarchically divided state spaces, the information processing device, comprising:
a learning object dataset reader configured to read a learning object dataset formed of a plurality of input columns and one or more output columns;
an importance degree calculator configured to calculate importance degrees of the individual input columns based on the learning object dataset;
an order generator configured to generate an order of the individual input columns to be a base of branch determination of the individual nodes, based on the individual importance degrees; and
a machine learning circuitry configured to perform the machine learning based on the learning object dataset and the order.

2. The information processing device according to claim 1, the order generator, further comprising:
a detailed order generator configured to generate the order such that the input column of a high importance degree corresponds to an upper node in the tree structure model.

3. The information processing device according to claim 1, wherein the individual importance degrees are generated based on relevancy between the individual input columns and the individual corresponding output columns.

4. The information processing device according to claim 3, wherein the relevancy is an absolute value of a correlation coefficient between the individual input columns and the individual corresponding output columns.

5. The information processing device according to claim 4, the order generator comprising:
a maximum correlation coefficient input column specification circuitry configured to specify the input column for which the correlation coefficient is maximum among the individual input columns and perform incorporation into the order;
a divider configured to divide the correlation coefficient of the input column specified as having the maximum correlation coefficient by a predetermined numerical value; and
a repetitive processor configured to repeatedly operate the maximum correlation coefficient input column specification circuitry and the divider for a predetermined number of times and generate the order of the individual input columns.

6. The information processing device according to claim 1, the order generator comprising:
an importance-degree-order order generator configured to generate the order of the individual input columns in order of the importance degrees of the individual input columns.

7. An information processing method which performs machine learning utilizing a tree structure model configured by branching and hierarchically arranging a plurality of nodes respectively corresponding to hierarchically divided state spaces, the information processing method, comprising:
reading a learning object dataset formed of a plurality of input columns and one or more output columns;
calculating importance degrees of the individual input columns based on the learning object dataset;
generating an order of the individual input columns to be a base of branch determination of the individual nodes, based on the individual importance degrees; and
performing the machine learning based on the learning object dataset and the order.

8. A non-transitory computer readable medium having stored thereon instructions wherein the instructions, when executed by a computer, cause the computer to function as an information processing device configured to perform machine learning utilizing a tree structure model configured by branching and hierarchically arranging a plurality of nodes respectively corresponding to hierarchically divided state spaces, the instructions further causing the computer to perform a method comprising:
reading a learning object dataset formed of a plurality of input columns and one or more output columns;
calculating importance degrees of the individual input columns based on the learning object dataset;
generating an order of the individual input columns to be a base of branch determination of the individual nodes, based on the individual importance degrees; and
performing the machine learning based on the learning object dataset and the order.
